(19) United States
(12) Patent Application Publication
(10) Pub. No.: US 2017/0053024 A1
(43) Pub. Date: Feb. 23, 2017

(54) TERM CHAIN CLUSTERING

(71) Applicant: HEWLETT PACKARD ENTERPRISE DEVELOPMENT LP, Houston, TX (US)

(72) Inventors: George Forman, Port Orchard, WA (US); Renato Keshet, Haifa (IL); Hila Nachlieli, Haifa (IL)

(21) Appl. No.: 15/306,803

(22) PCT Filed: Apr. 28, 2014
(86) PCT No.: PCT/US2014/035617

§ 371 Date: Oct. 26, 2016

(51) Int. Cl. G06F 17/30; G06N 99/00

(52) U.S. Cl. CPC G06F 17/30705; G06F 17/30684; G06N 99/005

(57) ABSTRACT

According to an example, term chain clustering may include receiving a set of training cases from a known category, and receiving a set of unlabeled cases that are to be analyzed with respect to the known category. A plurality of terms of the set of training cases from the known category, and the set of unlabeled cases that are to be analyzed, may be analyzed using a term scoring function to generate a score for each of the plurality of terms. A highest scoring term may be selected from the analyzed terms based on the score for each of the plurality of terms. A selected set that includes cases from the set of unlabeled cases that include the highest scoring term may be generated.

### BACKGROUND

Clustering is typically the task of grouping a set of objects in such a way that objects in the same group (e.g., cluster) are more similar to each other than to those in other groups (e.g., clusters). In a typical scenario, a user provides a clustering application with a plurality of objects that are to be clustered. The user also typically specifies a number of clusters that are needed, certain objects that are to be clustered together, and certain objects that are not to be clustered together. In response, the clustering application typically generates results including the number of clusters specified, with the clusters accounting for the specification of whether certain objects are to be clustered together, and certain objects that are not to be clustered together.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a term chain clustering apparatus, according to an example of the present disclosure;

FIG. 2 illustrates a flowchart for the term chain clustering apparatus of FIG. 1, according to an example of the present disclosure;

FIG. 3 illustrates a method for term chain clustering, according to an example of the present disclosure;

FIG. 4 illustrates further details of the method for term chain clustering, according to an example of the present disclosure; and

FIG. 5 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In a clustering application that generates clusters based on a number of clusters specified by a user, with the clusters accounting for the specification of whether certain objects are to be clustered together, and certain objects that are not to be clustered together, the resulting clusters may not be useful. For example, a clustering application may generate a predetermined number of clusters for documents related to boats based on color (e.g., red, blue, etc.) based on the prevalence of color-related terms in the documents. However, the generated clusters may be irrelevant to an area of interest (e.g., sinking boats, or boats run aground) to a user. In this regard, according to examples, a term chain clustering apparatus and a method for term chain clustering are disclosed herein to generate clusters that complement existing known categories of interest to a user. The aspect of complementing existing known categories may provide, for example, determination of new and emerging problems that are being reported about a company's products. For example, a data analyst or domain expert may determine new and emerging problems with respect to a company's products.

The apparatus disclosed herein may include a training case specification module to receive a set of training cases from a known category. A case may include a document or a record including a plurality of fields. For example, a case is a record from a customer support call log. According to another example, a case is a document related to a product. According to an example described herein, cases include documents related to boat issues generally. A category may represent an area of interest. For the example described herein, categories include sinking boats and boats run aground. For the example described herein, the set of training cases from the known category include cases related to sinking boats for the sinking boat category. Alternatively, for the example described herein, the set of training cases include training cases from known categories that include cases related to sinking boats for the sinking boat category, and boats run aground for the boats run aground category. Alternatively, for the example described herein, the categories and related cases may be combined into a single category that includes a plurality of sub-categories. For example, the set of training cases from a known category include cases related to sinking boats for the sinking boat sub-category, and boats run aground for the boats run aground sub-category.

The apparatus disclosed herein may further include an unlabeled case specification module to receive a set of unlabeled cases that are to be analyzed with respect to the known category. The set of unlabeled cases may include cases that are not known to belong to a known category, and may include cases that complement the known category. For the example described herein, the set of unlabeled cases may include cases related to boats of different colors, different models, boat accidents, boat fires, etc. For the example described herein, based on the analysis performed by the term chain clustering apparatus, cases related to boat fires or smoke may complement the known category.

The apparatus disclosed herein may further include a cluster size specification module to receive an indication of a target number of cases that are to be identified in a cluster that includes selected cases from the set of unlabeled cases that complement the known category. For example, the target number of cases that are to be identified in a cluster may be specified as 30 cases.

The apparatus disclosed herein may further include a term scoring module to analyze each term of the set of training cases from the known category, and the set of unlabeled cases that are to be analyzed with respect to the known category, using a term scoring function to generate a score for each term. A term may include a single word, a multi-word phrase of words that appear in the text of the cases (possibly selected after removing common “stop words” (e.g., “a”, “of”, “the”, etc.), and/or a set of co-occurring words (which may not appear adjacent to one another). A term may constitute the entire value for a field that is nominal, e.g., “no parts used”, or “parts used”, or “void.” For example, a term constitutes the entire value of “Puerto Rico”. On a case data field that contains a nominal value (e.g., a multiple-choice value among a limited set, e.g., “Has state driver's license,” “Has international driver's license,” “Driving illegally,” and “minor”), then a term may represent this field/value pair, e.g., a term may be “License=Has state driver's license.” A term may also represent a disjunction of other terms, e.g., “display OR screen” may be considered one term. A term may also be a conjunction of other terms, e.g., “screen AND cracked.” Such term pairings may be generated randomly, exhaustively from all term pairs, or selectively (e.g., selecting terms that co-occur more than some minimum count or percentage). Generally, a term may represent any concept that is associated with a case.

The apparatus and method disclosed herein may be used with datasets including text (and/or nominal fields, whose values may be represented by a phrase), and more generally, also with domains of data that may be converted into pseudo-documents with pseudo-terms, that is, cases including a variety of event types that may be extracted from raw data. For example, pseudo-terms may be extracted from numerical fields. In other words, pseudo-terms may be used to represent a range of (generally rare) values, such as “in top 1% of values” or “in bottom 5% of values.” For a numerical field, a term may represent a test for a single value, e.g., Height=6′, or it may represent a threshold value test, e.g., Height >=6′. Multimedia data types may have pseudo-terms extracted. For example, the scale-invariant feature transform (SIFT) process may be used to extract pseudo-terms from an image. According to another example, genre or type detectors may produce pseudo-term tags for audio and video data types. According to a further example, system event logs may be converted into pseudo-documents by considering each limited time window (on each system) as a pseudo-document, with pseudo-terms corresponding to particular event types. According to another example, continuous time series data may have various features extracted, e.g. leading to pseudo-terms that represent a sudden drop or a slow increase in value for one hour.

The apparatus disclosed herein may further include a term selection module to select a highest scoring term from the analyzed terms based on the score for each term. Alternatively, the term selection module may select a term including a predetermined ranking (e.g., highest, or one of the highest) from the analyzed terms based on the score for each term. As described herein, the term scoring function may be based on Chi-Squared, Bi-Normal Separation, Information Gain, Pearson Correlation, Mutual Information, Odds Ratio, Precision, F-measure, and/or Difference of two error functions, etc.

The apparatus disclosed herein may further include a selected set generation module to generate a selected set that includes cases from the set of unlabeled cases that include the highest scoring term.

The apparatus disclosed herein may further include a selected set evaluation module to determine a size of the selected set. As discussed in detail herein, based on the size of the selected set and the target number of cases that are to be identified in the cluster, further selected sets that include cases from previous selected sets that include respective highest scoring terms may be iteratively generated until a size of a last selected set is less than or equal to the target number of cases that are to be identified in the cluster.

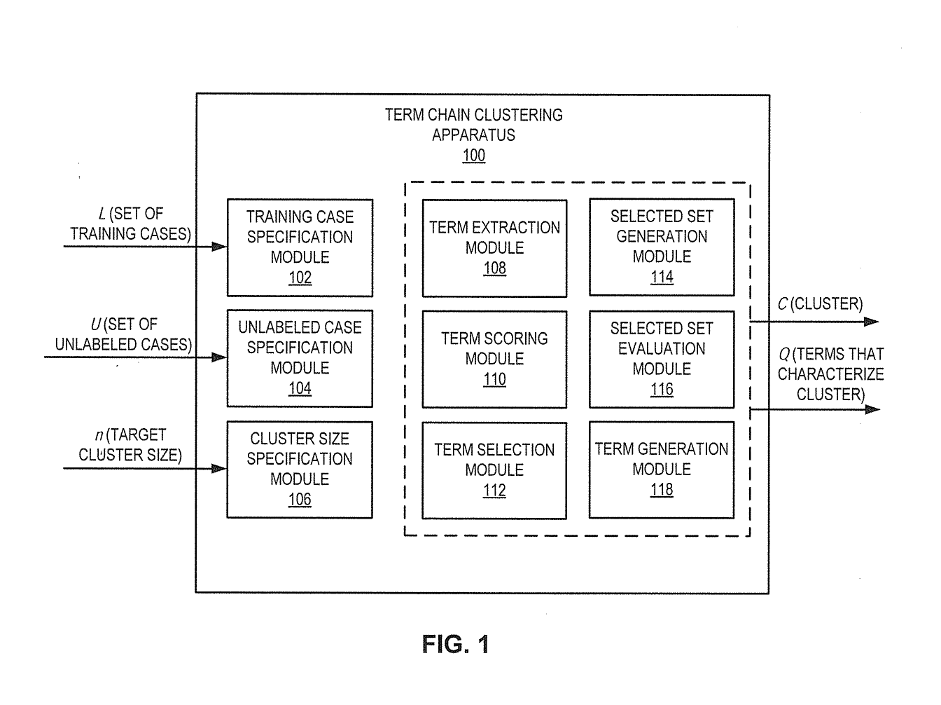

FIG. 1 illustrates an architecture of a term chain clustering apparatus (hereinafter also referred to as “apparatus 100”), according to an example of the present disclosure. Referring to FIG. 1, the apparatus 100 is depicted as including a training case specification module 102 to receive a set of training cases from a known category. Alternatively or additionally, the set of training cases may represent a plurality of known categories. According to an example, the set of training cases are designated as L. An unlabeled case specification module 104 is to receive a set of unlabeled cases that are to be analyzed with respect to the known category. According to an example, the set of unlabeled cases is designated as U. A cluster size specification module 106 is to receive an indication of a target number of cases that are to be identified in a cluster that includes selected cases from the set of unlabeled cases that complement the known category. According to an example, the target number of cases that are to be identified in a cluster is designated as n. Further, according to an example, the cluster that is returned is designated as C.

Generally, the values for the variables L, U, and n may be designated as input values for the apparatus 100. Further, generally, the values for the variables C and Q (a list of terms that characterize the cluster C, as described herein) may be designated as output values for the apparatus 100.

A term extraction module 108 is to extract terms t from the set of training cases L from the known category, and the set of unlabeled cases U that are to be analyzed with respect to the known category. A term scoring module 110 is to analyze each term t (or a plurality of terms t) of the set of training cases L from the known category, and the set of unlabeled cases U that are to be analyzed with respect to the known category, using a term scoring function to generate a score for each term t. A term selection module 112 is to select a highest scoring term t from the analyzed terms based on the score for each term t. A selected set generation module 114 is to generate a selected set that includes cases from the set of unlabeled cases that include the highest scoring term t. According to an example, the selected set is designated as S.

A selected set evaluation module 116 is to determine a size of the selected set S. The selected set evaluation module 116 may compare a size of the selected set S to the target number n of cases that are to be identified in the cluster C. In response to a determination that the size of the selected set S is greater than the target number n of cases that are to be identified in the cluster, processing may revert to the term scoring module 110 to analyze each remaining term t of the set of training cases from the known category, and the set of cases from the selected set S, by using the term scoring function to generate a further score for each remaining term t. Further, the term selection module 112 may select a highest scoring remaining term from the analyzed remaining terms t based on the further score for each remaining term t. The selected set generation module 114 may generate a further selected set that includes cases from the selected set S that include the highest scoring remaining term. The selected set S may be output as a cluster C if a size of the selected set S is equal to the target number n of cases that are to be identified in the cluster C. In this manner, the size of the selected set S may be reduced until the size of the selected set S is less than or equal to the target number n of cases that are to be identified in the cluster C. Generally, further selected sets that include cases from previous selected sets that include respective highest scoring terms may be iteratively generated until a size of a last selected set is less than or equal to the target number of cases that are to be identified in the cluster C.

With respect to the selected set evaluation module 116, in response to a determination that the size of the selected set is less than or equal to the target number n of cases that are to be identified in the cluster C, the selected set evaluation module 116 may designate the selected set as the cluster that complements the known category. Further, in response to a determination that the size of the selected set is less than the target number n of cases that are to be identified in the cluster C, additional cases that include fewer highest scoring terms may be added to the cluster C until a size of the cluster C is equal to the target number n of cases that are to be identified in the cluster C.

A term generation module 118 is to generate a list of the highest scoring terms that characterize the cluster C. According to an example, the list of each of the highest scoring terms that characterize the cluster C is designated as Q.

The modules and other elements of the apparatus 100 may be machine readable instructions stored on a non-transitory computer readable medium. In this regard, the apparatus 100 may include or be a non-transitory computer readable medium. In addition, or alternatively, the modules and other elements of the apparatus 100 may be hardware or a combination of machine readable instructions and hardware.

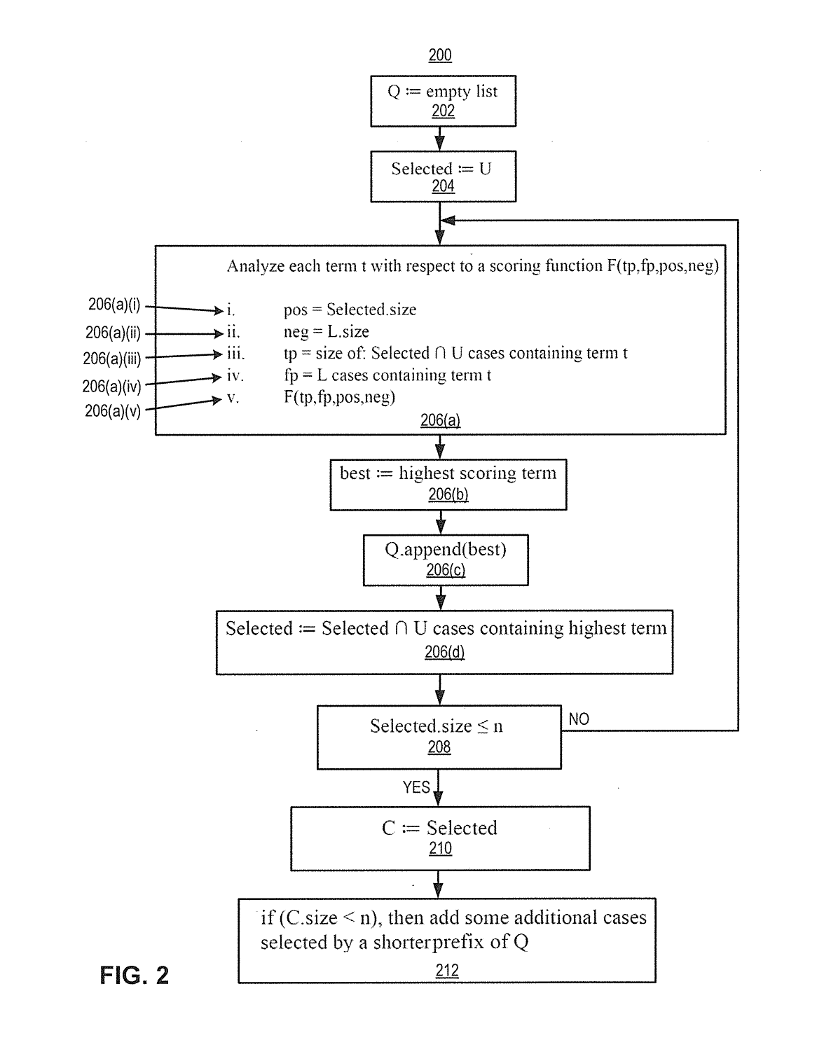

FIG. 2 illustrates a flowchart 200 for the term chain clustering apparatus 100, according to an example of the present disclosure;

Referring to FIGS. 1 and 2, with respect to the flowchart 200, the training case specification module 102 may receive a set of training cases L from a known category. According to an example related to boats as described herein, the set of training cases L is related to a known category of sinking boats and boats run aground, and includes 50 cases. The unlabeled case specification module 104 may receive a set of unlabeled cases U that are to be analyzed with respect to the known category. According to the example related to boats as described herein, the set of unlabeled cases U includes cases related to boats of different colors, different models, boat accidents, boat fires, etc., and includes 10000 cases. The cluster size specification module 106 may receive an indication of a target number of cases n that are to be identified in a cluster C that includes selected cases from the set of unlabeled cases that complement the known category. According to the example related to boats as described herein, the cluster size is specified as 30 cases.

For the flowchart 200, at block 202, the list Q of terms that characterize the cluster C may be set to empty.

At block 204, the selected set S of cases may be initially specified as the set of unlabeled cases U.

At block 206(a), the term scoring module 110 may analyze each term t of the set of training cases L from the known category, and the set of unlabeled cases U that are to be analyzed with respect to the known category, using a term scoring function to generate a score for each term t. Specifically, the term scoring module 110 may analyze each term t with respect to a term scoring function F(tp,fp,pos,neg). A user may also specify any particular stop term that is not to be used to form a cluster regardless of the score of the stop term. In this case, the term scoring module 110 may analyze each term t, except for the stop term, with respect to the term scoring function F(tp,fp,pos,neg).

At 206(a)(i), with respect to the term scoring function F(tp,fp,pos,neg), the variable pos is set to the size of the selected set S of cases. Since the selected set S is specified as the set of unlabeled cases U, initially, the variable pos is set to the size of the set of unlabeled cases U.

At 206(a)(ii), the variable neg is set to the size of set of training cases L.

At 206(a)(iii), the variable tp is set to the size of the number of cases of the selected set S that intersect with the set of unlabeled cases U containing the term t being evaluated.

At 206(a)(iv), the variable fp may represent the set of training cases L containing the term t being evaluated.

At 206(a)(v), the term scoring function F(tp,fp,pos,neg) may be used to score the term t being evaluated. The term scoring function F(tp,fp,pos,neg) may be based on Chi-Squared, Bi-Normal Separation, Information Gain, Pearson Correlation, Mutual Information, Odds Ratio, Precision, F-measure, and/or Difference of two error functions, etc. For example, the Pearson Correlation-based term scoring function may represent a measure of the linear correlation (dependence) between two variables X and Y, giving a value between +1 and −1 inclusive, where 1 is total positive correlation, 0 is no correlation, and −1 is total negative correlation. The term scoring function F(tp,fp,pos,neg) may provide the degree of linear dependence between two variables. The Chi-Squared-based term scoring function may be based on a chi-squared sampling distribution. The Bi-Normal Separation scoring function involves the inverse cumulative distribution function of a standard probability distribution. Information Gain and Difference of two error functions may be similarly used to define a measure of correlation between two quantities. Mutual Information of two random variables is a measure of the variables' mutual dependence. Odds Ratio is a way to quantify how strongly the presence or absence of property A is associated with the presence or absence of property B in a given population. Precision may be related to the definition of a quantity in a specific way. Further, F-measure is a measure of a test's accuracy.

According to an example, with respect to the term scoring function F(tp,fp,pos,neg), an unacceptable score may be given to any term t with tp/pos>25%. Any terms that are assigned an unacceptable score may be discarded. Further, an unacceptable score may be given to any term t that appears in less than a predetermined number of unlabeled cases (e.g., a term that appears in <10 unlabeled cases). Further, an unacceptable score may be given to any term t that is on a stop list. Further, the positives may be normalized to be a predetermined percentage of the negatives. Generally, the positives may be normalized to be between approximately 10%-50% of the negatives. According to an example, the positives are normalized to be a third of the negatives, i.e. pos′=neg*33%, and tp′=(tp/pos)*neg*33%. For example, a Pearson Correlation score is computed as follows:

score=((tp−x*pos/T)/(x−x²/T))* sqrt((x−x²/T)/(T−1))/sqrt((pos−pos²/T)/(T−1)), where x=fp+tp and T=pos+neg.

At block 206(b), the term selection module 112 may select a highest scoring term t from the analyzed terms based on the score for each term t. According to the example related to boats as described herein, assuming the highest scoring term is “fire”, the term selection module 112 selects the term “fire”.

At block 206(c), the list Q of terms that characterize the cluster C is appended to include the highest scoring term t. According to the example related to boats as described herein, the list Q of terms that characterize the cluster C is appended to include the term “fire”.

At block 206(d), the selected set S is set to the cases in the selected set S that intersect with the unlabeled cases U containing the highest scoring term t. For example, the selected set generation module 114 may generate a selected set S that includes cases in the previous selected set S that intersect with the unlabeled cases U containing the highest scoring term t. According to the example related to boats as described herein, the selected set generation module 114 may generate a selected set S that includes cases in the previous selected set S that intersect with the unlabeled cases U containing the highest scoring term “fire”.

At block 208, the selected set evaluation module 116 may determine a size of the selected set. According to the example related to boats as described herein, assuming the selected set has 400 cases, the selected set evaluation module 116 may determining a size of the selected set as 400. The selected set evaluation module 116 may compare a size of the selected set S to the target number n of cases that are to be returned in the cluster C. In response to a determination that the size of the selected set S is greater than the target number n of cases that are to be identified in the cluster, processing may revert to block 206(a) where the term scoring module 110 analyzes each remaining term t of the set of training cases from the known category, and the set of cases from the selected set S, by using the term scoring function to generate a further score for each remaining term. According to the example related to boats as described herein, since the size (e.g., 400) of the selected set S is greater than the target number n (e.g., 30) of cases that are to be identified in the cluster, processing may revert to block 206(a) where the term scoring module 110 analyzes each remaining term t of the set of training cases from the known category, and the set of cases from the selected set S, by using the term scoring function to generate a further score for each remaining term.

Further, the term selection module 112 may select a highest scoring remaining term from the analyzed remaining terms based on the further score for each remaining term. The selected set generation module 114 may generate a further selected set that includes cases from the selected set that include the highest scoring remaining term. According to the example related to boats as described herein, assuming the highest scoring remaining term is “smoke”, the selected set generation module 114 may generate a further selected set that includes cases from the selected set that include the highest scoring remaining term.

The selected set S may be output as a cluster C if a size of the selected set S is equal to the target number n of cases. In this manner, the size of the selected set S may be reduced until the size of the selected set S is less than or equal to the target number n of cases. Generally, further selected sets that include cases from previous selected sets that include respective highest scoring terms may be iteratively generated until a size of a last selected set is less than or equal to the target number of cases that are to be identified in the cluster C. According to the example related to boats as described herein, assuming additional highest scoring terms are “engine”, and “problem”, after which a size of a last selected set is 25 (i.e., less than or equal to the target number of cases that are to be identified in the cluster C), processing at block 208 is concluded.

At block 210, the cluster C may be set as the selected set S.

At block 212, the selected set evaluation module 116 may compare a size of the cluster C to the target number n of cases that are to be returned in the cluster C. In response to a determination that the size of the selected set is less than or equal to the target number n of cases that are to be identified in the cluster C, the selected set evaluation module 116 may designate the selected set as the cluster that complements the known category. Further, in response to a determination that the size of the selected set is less than the target number n of cases that are to be identified in the cluster, additional cases that include fewer highest scoring terms may be added to the cluster C until a size of the cluster C is equal to the target number n of cases that are to be identified in the cluster C. According to the example related to boats as described herein, since the size (e.g., 25) of the selected set is less than the target number n (e.g., 30) of cases that are to be identified in the cluster, additional cases that include fewer highest scoring terms (e.g., cases including terms fire, smoke, and engine; not, including problem) may be added to the cluster C until a size of the cluster C is equal to the target number n of cases that are to be identified in the cluster C. According to the example related to boats as described herein, the list Q of terms that characterize the cluster C includes the terms fire, smoke, engine, and problem.

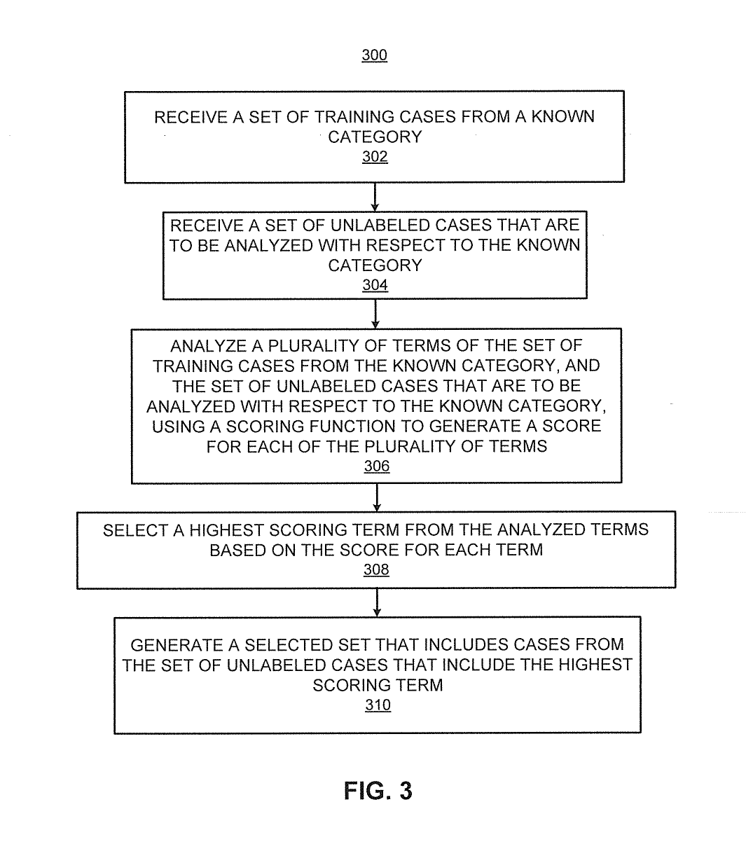

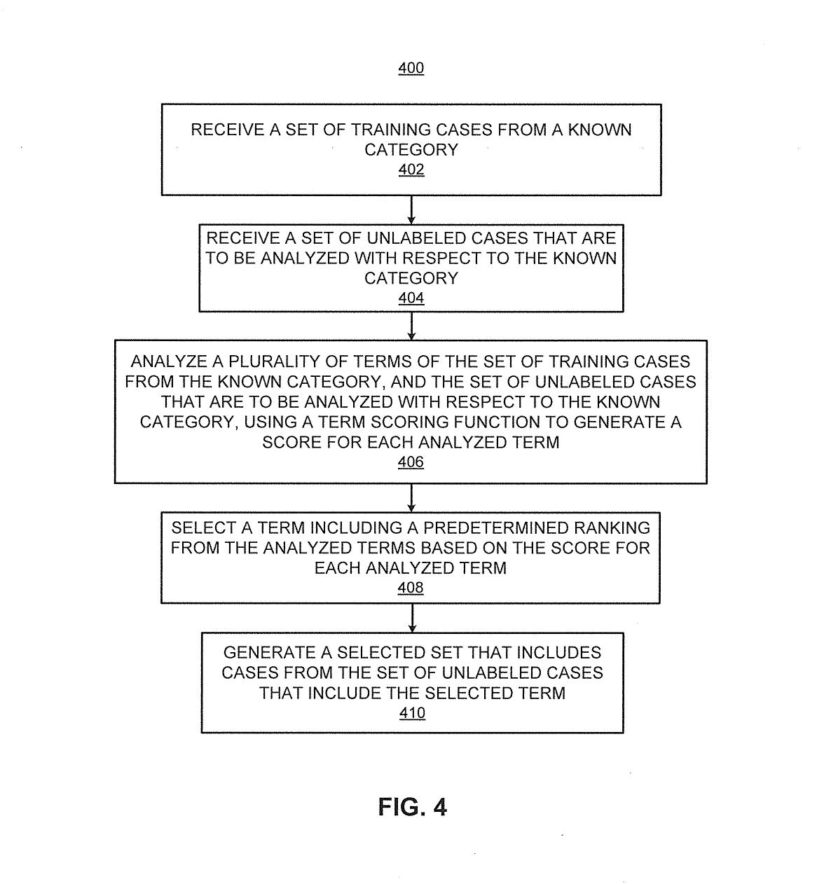

FIGS. 3 and 4 respectively illustrate flowcharts of methods 300 and 400 for term chain clustering, corresponding to the example of the term chain clustering apparatus 100 whose construction is described in detail above. The methods 300 and 400 may be implemented on the term chain clustering apparatus 100 with reference to FIGS. 1 and 2 by way of example and not limitation. The methods 300 and 400 may be practiced in other apparatus.

Referring to FIG. 3, for the method 300, at block 302, the method may include receiving a set of training cases from a known category. For example, referring to FIG. 1, the training case specification module 102 may receive a set of training cases from a known category.

At block 304, the method may include receiving a set of unlabeled cases that are to be analyzed with respect to the known category. For example, referring to FIG. 1, the unlabeled case specification module 104 may receive a set of unlabeled cases that are to be analyzed with respect to the known category.

At block 306, the method may include analyzing a plurality of terms of the set of training cases from the known category, and the set of unlabeled cases that are to be analyzed with respect to the known category, using a term scoring function to generate a score for each of the plurality of terms. For example, referring to FIG. 1, the term scoring module 110 may analyze a plurality of terms t of the set of training cases L from the known category, and the set of unlabeled cases U that are to be analyzed with respect to the known category, using a term scoring function to generate a score for each of the plurality of terms t. According to an example, analyzing a plurality of terms of the set of training cases from the known category, and the set of unlabeled cases that are to be analyzed with respect to the known category, using a term scoring function to generate a score for each of the plurality of terms, may further include assigning an unacceptable score to a term if a size of a number of cases of the set of unlabeled cases containing the term being analyzed divided by a size of the selected set is greater than a predetermined percentage, the term being analyzed appears in less than a predetermined number of unlabeled cases, and/or the term being analyzed is on a stop list. According to an example, the predetermined percentage is approximately 25%.

At block 308, the method may include selecting a highest scoring term from the analyzed terms based on the score for each of the plurality of terms. For example, referring to FIG. 1, the term selection module 112 may select a highest scoring term t from the analyzed terms based on the score for each of the plurality of terms t.

At block 310, the method may include generating a selected set that includes cases from the set of unlabeled cases that include the highest scoring term. For example, referring to FIG. 1, the selected set generation module 114 may generate a selected set that includes cases from the set of unlabeled cases that include the highest scoring term t.

According to an example, the method 300 may include receiving an indication of a target number of cases that are to be identified in a cluster that includes selected cases from the set of unlabeled cases that complement the known category. For example, referring to FIG. 1, the cluster size specification module 106 may receive an indication of a target number of cases that are to be identified in a cluster that includes selected cases from the set of unlabeled cases that complement the known category.

According to an example, the method 300 may include determining a size of the selected set, and in response to a determination that the size of the selected set is greater than the target number of cases that are to be identified in the cluster, analyzing each remaining term of the set of training cases from the known category, and the set of cases from the selected set, using the term scoring function to generate a further score for each remaining term. For example, referring to FIG. 1, the selected set evaluation module 116 may determine a size of the selected set S. The method 300 may further include selecting a highest scoring remaining term from the analyzed remaining terms based on the further score for each remaining term, and generating a further selected set that includes cases from the selected set that include the highest scoring remaining term.

According to an example, the method 300 may include receiving an indication of a total number of highest scoring terms, and iteratively generating further selected sets that include cases from previous selected sets that include respective highest scoring terms until a total number of the respective highest scoring terms is equal to the indicated total number of highest scoring terms.

According to an example, the method 300 may include determining a size of the selected set, and iteratively generating further selected sets that include cases from previous selected sets that include respective highest scoring terms until a size of a last selected set is less than or equal to the target number of cases that are to be identified in the cluster.

According to an example, the method 300 may include determining a size of the selected set, and in response to a determination that the size of the selected set is less than or equal to the target number of cases that are to be identified in the cluster, designating the selected set as the cluster that complements the known category.

According to an example, the method 300 may include determining a size of the selected set, in response to a determination that the size of the selected set is less than the target number of cases that are to be identified in the cluster, designating the selected set as the cluster that complements the known category, and adding additional cases that include fewer highest scoring terms to the cluster until a size of the cluster is equal to the target number of cases that are to be identified in the cluster.

According to an example, the method 300 may include iteratively generating a further selected set by adding the selected set to the set of training cases from the known category. For example, the selected set that is generated by the selected set generation module 114 may be added to the known category of cases (i.e., removed from the unlabeled set U and added to the set of training cases L) , and a further selected set may be generated from the revised unlabeled set U. In this manner, a variety of different clusters that each complement the collected clusters may be identified. For example, given the known categories of “hard disk problems” and “display problems”, a first iteration may generate a cluster of cases with “keyboard problems”, and further iterations may generate clusters that contain “touch pad problems,” then “fan problems,” then “AC adapter problems,” etc.

Referring to FIG. 4, for the method 400, at block 402, the method may include receiving a set of training cases from a known category.

At block 404, the method may include receiving a set of unlabeled cases that are to be analyzed with respect to the known category.

At block 406, the method may include analyzing a plurality of terms of the set of training cases from the known category, and the set of unlabeled cases that are to be analyzed with respect to the known category, using a term scoring function to generate a score for each analyzed term.

At block 408, the method may include selecting a term including a predetermined ranking from the analyzed terms based on the score for each analyzed term.

At block 410, the method may include generating a selected set that includes cases from the set of unlabeled cases that include the selected term.

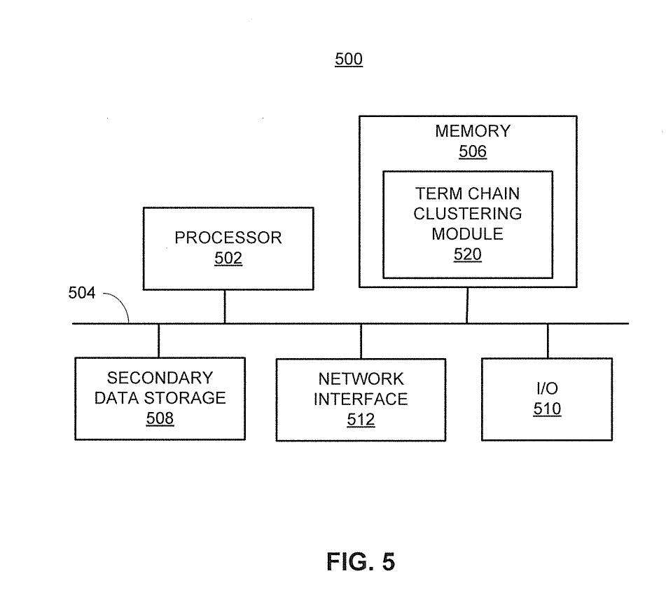

FIG. 5 shows a computer system 500 that may be used with the examples described herein. The computer system 500 may represent a generic platform that includes components that may be in a server or another computer system. The computer system 500 may be used as a platform for the apparatus 100. The computer system 500 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 500 may include a processor 502 that may implement or execute machine readable instructions performing some or all of the methods, functions and other processes described herein. Commands and data from the processor 502 may be communicated over a communication bus 504. The computer system may also include a main memory 506, such as a random access memory (RAM), where the machine readable instructions and data for the processor 502 may reside during runtime, and a secondary data storage 508, which may be non-volatile and stores machine readable instructions and data. The memory and data storage are examples of computer readable mediums. The memory 506 may include a term chain clustering module 520 including machine readable instructions residing in the memory 506 during runtime and executed by the processor 502. The term chain clustering module 520 may include the modules of the apparatus 100 shown in FIG. 1.

The computer system 500 may include an I/O device 510, such as a keyboard, a mouse, a display, etc. The computer system may include a network interface 512 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for term chain clustering, the method comprising:
receiving a set of training cases from a known category;
receiving a set of unlabeled cases that are to be analyzed with respect to the known category;
analyzing, by a processor, a plurality of terms of the set of training cases from the known category, and the set of unlabeled cases that are to be analyzed with respect to the known category, using a term scoring function to generate a score for each of the plurality of terms;
selecting a highest scoring term from the analyzed terms based on the score for each of the plurality of terms; and
generating a selected set that includes cases from the set of unlabeled cases that include the highest scoring term.

2. The method of claim 1, further comprising:
receiving an indication of a target number of cases that are to be identified in a cluster that includes selected cases from the set of unlabeled cases.

3. The method of claim 2, further comprising:
determining a size of the selected set;
in response to a determination that the size of the selected set is greater than the target number of cases that are to be identified in the cluster, analyzing each remaining term of the set of training cases from the known category, and the set of cases from the selected set, using the term scoring function to generate a further score for each remaining term;
selecting a highest scoring remaining term from the analyzed remaining terms based on the further score for each remaining term;
generating a further selected set that includes cases from the selected set that include the highest scoring remaining term.

4. The method of claim 1, further comprising:
receiving an indication of a total number of highest scoring terms; and
iteratively generating further selected sets that include cases from previous selected sets that include respective highest scoring terms until a total number of the respective highest scoring terms is equal to the indicated total number of highest scoring terms.

5. The method of claim 2, further comprising:
determining a size of the selected set; and
in response to a determination that the size of the selected set is less than or equal to the target number of cases that are to be identified in the cluster, designating the selected set as the cluster that complements the known category.

6. The method of claim 2, further comprising:
determining a size of the selected set;
in response to a determination that the size of the selected set is less than the target number of cases that are to be identified in the cluster, designating the selected set as the cluster that complements the known category; and
adding additional cases that include fewer highest scoring terms to the cluster until a size of the cluster is equal to the target number of cases that are to be identified in the cluster.

7. The method of claim 1, wherein analyzing a plurality of terms of the set of training cases from the known category, and the set of unlabeled cases that are to be analyzed with respect to the known category, using a term scoring function to generate a score for each of the plurality of terms, further comprises:
assigning an unacceptable score to a term if at least one of:
a size of a number of cases of the set of unlabeled cases containing the term being analyzed divided by a size of the selected set is greater than a predetermined percentage;
the term being analyzed appears in less than a predetermined number of unlabeled cases; and
the term being analyzed is on a stop list.

8. The method of claim 2, further comprising:
generating a list of highest scoring terms that characterize the cluster.

9. The method of claim 1, wherein a term of the analyzed terms includes an entire value for a field that is a nominal.

10. A term chain clustering apparatus comprising:
a processor; and
a memory storing machine readable instructions that when executed by the processor cause the processor to:
receive a set of training cases from a known category;
receive a set of unlabeled cases that are to be analyzed with respect to the known category;
receive an indication of a target number of cases that are to be identified in a cluster that includes selected cases from the set of unlabeled cases;
analyze each term of the set of training cases from the known category, and the set of unlabeled cases that are to be analyzed with respect to the known category, using a term scoring function to generate a score for each term;
select a term including a predetermined ranking from the analyzed terms based on the score for each term; and
generate a selected set that includes cases from the set of unlabeled cases that include the selected term.

11. The term chain clustering apparatus according to claim 10, wherein the term scoring function is based on at least one of Chi-Squared, Bi-Normal Separation, Information Gain, Pearson Correlation, Mutual Information, Odds Ratio, Precision, F-measure, and Difference of two error functions.

12. The term chain clustering apparatus according to claim 10, wherein the machine readable instructions that when executed by the processor further cause the processor to:
iteratively generate a further selected set by adding the selected set to the set of training cases from the known category.

13. A non-transitory computer readable medium having stored thereon machine readable instructions to provide term chain clustering, the machine readable instructions, when executed, cause a processor to:
receive a set of training cases from a known category;
receive a set of unlabeled cases that are to be analyzed with respect to the known category;
analyze a plurality of terms of the set of training cases from the known category, and the set of unlabeled cases that are to be analyzed with respect to the known category, using a term scoring function to generate a score for each analyzed term;
select a term including a predetermined ranking from the analyzed terms based on the score for each analyzed term; and
generate a selected set that includes cases from the set of unlabeled cases that include the selected term.

14. The non-transitory computer readable medium according to claim 13, wherein a case from at least one of the set of training cases and the set of unlabeled cases includes a document or a record including a plurality of fields.

15. The non-transitory computer readable medium according to claim 13, wherein a term of the analyzed terms includes a word or word phrase.
